(19) United States
(12) Patent Application Publication
(10) Pub. No.: US 2004/0048103 A1
(43) Pub. Date: Mar. 11, 2004

(54) Extruded plastic tape

(76) Inventor: Roger Walsh, Belleville (CA)

Correspondence Address: D.W. EGGINS, 18 DOWNSVIEW DRIVE, BARRIE, ON, L4M 4P8, CA

(21) Appl. No.: 10/655,011

(22) Filed: Sep. 5, 2003

(30) Foreign Application Priority Data
Sep. 11, 2002 (CA) 2,404,525

(51) Int. Cl. B28B 3/20

(52) U.S. Cl. 428/690; 264/176.1

(57) ABSTRACT

A plastic tape includes rare earth phosphors combined with fluorescent material, providing in low-light conditions unusual visibility of long duration. The extruded tape has tapered edges to hug the ground, and to promote aerodynamic movement, when suspended. The tape mid-section may have an irregularly corrugated, crenelated surface with a shirred, lace-like appearance on its intermediate surfaces. Proposed uses include vertical Venetian blinds; as a non-skid marking tape for boundaries or routes; as a cushioning elastic wrap for handles; and as an emergency “light” or marker for hospital corridors, aircraft aisles, emergency exit routes, and on the clothing of road workers, cyclists etc and the marking of boats and docks, marker buoys defining safe swimming areas, swimming pools, patios etc. Light reflectivity may be added by incorporating aluminium glitter material. Protection against ultra-violet (u/v) damage may also be incorporated.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

1. This invention is directed to an extruded plastic tape having a light reactive surface that may include a crenelated surface of irregular formation, and tapered edges; the tape having a wide range of visual, decorative and practical uses, with strong safety aspects.

2. There exists a widespread need for convenient, how-cost safety markers, with particular emphasis on high visibility, particularly in conditions of darkness or poor lighting.

The fluorescent and reflective tapes presently available are mainly characterized by being self adhesive and being possessed of limited visibility, in that the orientation to the viewer of the surface to which such tape is adhered, is critical.

One of the major advantages of plastic is its flexibility and ease of fabrication by way of extrusion. However, one of the disadvantages of this is that an extremely uniform product is consistently produced, the uniformity of which diminishes its attraction for many decorative applications.

Furthermore, the production of plastics materials through a die has led to a longitudinally smooth surface, formed in conformity with the die surface. While in many uses this is favourable, in some instances this smooth surface is highly undesirable, as it may be very slippery, when positioned on the ground.

### BRIEF SUMMARY OF THE INVENTION

It has been found that a group of plastics can be produced that include rare earth phosphors combined with fluorescent material, to provide a tape having unusual visibility in after-dark and in poor light conditions such as dusk and pre-dawn. The elastic nature of the selected plastics facilitates use of the tape as a marking medium, including use as a boundary or route marker, as well as a proximity marker for obstacles.

The cross-sectional profile form of one embodiment of the tape, by way of a tapered edge, facilitates its use upon the ground, and when freely suspended, promotes aerodynamic motion to enhance the visual prominence of the tape in a boundary or location marking function.

In one tape embodiment, when extruded through a die under carefully controlled conditions of temperature and extrusion rate, an irregular crenelated surface finish may be produced. In this case, while the ribbon width is constant, the surface between the ribbon edges is deformed out of the plane of the ribbon edges, in a non-repetitive pattern of random rib-like protrusions, interspersed with marked, non-protruding surface portions having a shirred ‘gekko’-like appearance, somewhat akin to the look of the skin of the foot of a Gecko lizard or of lace curtaining.

One use of this novel section is as a vertical venetian blind. Another contemplated use is as an an elastic tie, wherein both the gripping and the elastic properties are of high capability. When used on the ground, the rough face constitutes a non-skid surface. Giving the tape section a fine tapered edge has been found to convey unusual aerodynamic characteristics. Thus, by suspending a length of such tape in a slightly twisted, tensioned condition between a pair of spaced supports it has been found that a marked dynamic twisting action occurs under slightly breezy conditions, with the visually prominent point of twist moving rapidly up and down the length of the tape.

Other, more standard profiles may incorporate the phosphor and fluorescent materials.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 is a plan view of a first embodiment extruded tape in accordance with the present invention;

FIG. 1G is a plan view of a first embodiment extruded tape portraying the subject ‘gecko’ appearance;

FIG. 2 is a perspective view of a length of a second embodiment extruded tape in accordance with the present invention; and

FIG. 3 is a cross section of a third tape embodiment.

FIGS. 4 and 5 are cross-section views of further embodiments; and,

FIG. 6 is an elevational view of a support post for use with a driveway marker tape.

### DETAILED DESCRIPTION OF THE INVENTION

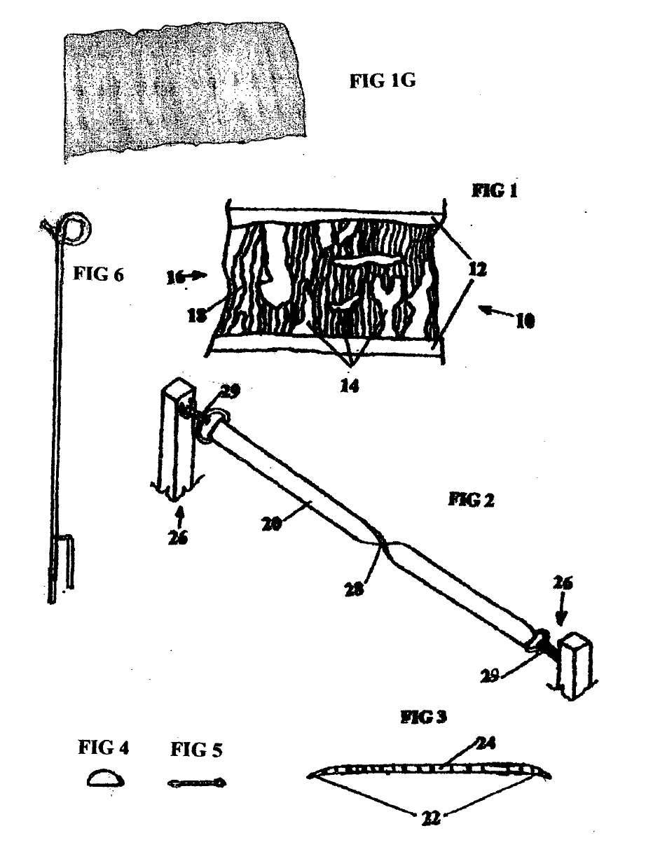

Referring to the FIG. 1 embodiment, a short length of tape 10 is shown, having plain, substantially planar edge portions 12. Irregular, randomly spaced raised “island” portions 14 arc distributed upon the surface of the centre portion 16 of the tape 10, the portions 14 being substantially solid. The intervening spaces between the islands 14 arc covered with a series of very fine closely spaced ripple-like transversely extending protrusions 18, giving a shirred lace-like visual appearance. FIG. 1G shows a series of very fine closely spaced ripple-like transversely extending larger protrusions 19, giving a Gecko's foot-like visual appearance.

Turning to FIG. 2, a length of tape 20 having a cross sectional profile as shown in FIG. 3, with tapered edges 22 and a substantially planar intermediate portion 24, is shown tied in tensioned relation between a pair of support posts.

The tape 20 has a twist 28 imparted by the supporting oords 29. In use, the effect of a slight breeze is to cause twist 28 to displace up and down, along the length of the tape 20.

The tapered-edge tape 20 or the tape 10 embodiment can be laid out on the ground and secured in place, to mark paths, pitches, dc, (or suspended to form a barrier) so as to delineatc or mark off designated or embargoed locations and areas.

The subject tapes may be extruded from plastic elastomers such as DuPont polyolefin “Engage” (T.M.)-8003, which is extremely weather resistant.

The introduction of phosphorescent pigments, such as GTA Inc, PL, S, R or M series or Lunbo Photo luminescent pigments to the mix results in tapes of long term light emissivity, up to as much as 12 hours to 20 hours duration, The phosphors include colours of light yellow, Light green, light White, red, orange, green and blue.

These phosphorescent pigments are non-toxic, non-radioactive, being free of any radioactive additives; and consist of alkaline aluminate, activated by rare earth ions.

The addition of a small percentage of fluorescent material or LISA-Light Collecting Plastics by Bayer AG significantly enhances the brightness of the lighte emission—particularly under poor light conditions of less than total darkness.

The addition of a small percentage aluminum “giitter niblets” to the surface of the tape provides an effective reflective characteristic to the tape, when illuminated such as by vehicle headlights.

In one polyolefin embodiment, the addition of a U/V stabilizer, such as 1% by weight of a hundred amine, combined with 20-weight percent of rare earth yellow-green phosphorescent, plus one half weight percent of a green fluorescent, produced a tape with a high degree of brightness and extended emissivity.

Giving the tape section a fine tapered edge has been found to convey unusual aerodynamic characteristics. By suspending a length of such tape in a slightly twisted, tensioned condition between a pair of spaced supports it has been found that a most dynamic twisting action occurs under slightly breezy conditions with the visually prominent point of twist moving rapidly up and down along the tape.

The inclusion of a phosphorescent element into the melt from which the extrusion is made results in a visually prominent locator/indicator marker, readily identified in the dark.

One use, with safety implications, is as a route or boundary marking means, which can include the corridors of hospitals, nursing homes, resident's rooms a line from bed to bathroom, the aisles of an aircraft, emergency exit routes, or the sidelines of sports fields, soccer pitches, etc.

Other uses include wearing by cyclist, pedestrians, road workers; the marking of boats and docks, marker buoys defining safe swimming pool boundaries. Such uses are greatly facilitated by the elastic nature of the tape.

The addition of a small percentage of fluorescent material to supplement the phosphorescent material has been found to significantly enhance the visual prominence of the tape under intermediate lighting conditions, such as at dusk or dawn.

Use of the material as a low level light source, such as emergency and night tight when applied to lamp shades/ceiling light fixtures, telephones or a route or boundary assistance for the visually impaired, is contemplated, particularly in view of the long period of emissivity achieved by the use of phosphorescent rare earth.

Light reflectivity of the material can be promoted by the addition of a small amount of aluminum glitter material. Protection against ultra-Violet (u/v) damage is generally incorporated. The use of phosphors combined with fluorescent material provide a tape having unusual visibility in-after-dark and poor light conditions such as at dusk and pre-dawn times.

The elastic nature of the selected plastics facilitates use of the tape as a marking medium, including use as a boundary or route marker, as well as a proximity marker for obstacles.

The cross sectional profile form of one embodiment of the tape, by way of a tapered edge, facilitates its use upon the ground and when freely suspended, promotes aerodynamic motion to enhance the visual prominence of the tape in a boundary or location marking function.

In one tape embodiment, when extruded through a die under carefully controlled conditions of temperature and extrusion rate, an irregular crenulated surface finish may be produced. In this case, while the ribbon width is constant, the surface between the ribbon edges is deformed out of plane of the ribbon, in a non-repetitive pattern of random rib-like protrusions, interspersed with marked, non-protruding surface portions having a shirred-like appearance, somewhat akin to the look of lace curtaining and rib-like folds similar to the skin of a Gecko.

One novel use is as a vertical Venetian blind. Another contemplated use is as an elastic tie and handle cushion grip wrap, which eliminates abrasive hardness & vibration, for canes, walkers, tool handles, including motorized equipment such as chain saw and gas trimmers. etc wherein both the self-gripping and elastic properties are well utilized.

When used on the ground as a ground marker, the rough face of the tape forms a non-skid surface.

FIG. 4 shows a more standard, trim profile, and FIG. 5 shows a trim or tie profile, both of which may incorporate the phosphors and fluorescent materials.

FIG. 6 shows a ground spike having a split top-ring, into which the tape of FIG. 2 may be slid laterally. This enables the tape to be laid out on the ground, the ground spikes positioned as desired and driven into the ground, and the tape then slid laterally in supported relation within the split ring. The tape ends may be tied-off to the rings of the respective ground spikes.

1. An extruded sheet-like plastic product of predetermined thickness for use in marking, said product including a phosphorescent material, to provide long term light emission when exposed to light,

2. The product as set forth in claim 1, wherein said product further includes a fluorescent material, to enhance light emissivity perceived in intermediate lighting conditions.

3. The product as set forth in claim 1, being in the form of a tape

4. The product as set forth in claim 3, said plastic being a polyolefin elastomer possessing high resistance to weathering.

5. The product as set forth in claim 1, said phosphorescent material being a pigment having long term light emissivity, up to as much as 12-hours,

6. The product as set forth in claim 5, said phosphorescent material having a colour selected from the group consisting of light yellow, light green, light white, red, orange, green and blue

7. The product as set forth in claim 6, said phosphorescent material being non-toxic, non-radioactive, and free of any radioactive additives; and consisting of alkaline earth aluminate, actuated by rare earth ions

8. The product as set forth in claim 2., said plastic containing 20-weight percent rare-earth yellow-green phosphorescent, plus one-half weight percent of a green fluorescent, to provide a high degree of brightness and extended hours of emissivity.

9. The product as set forth in claim 2, having a small percentage of aluminum glitter niblets added in the surface of the product, to provide a reflective characteristic to the product, when illuminated.

10. The product as set forth in claim 1, wherein said product is a polyolefin tape, being a thermoplastic elastomer containing about 1% by weight of a U/V stabilizer; about 20 weight percent rare earth yellow-green phosphorescent; with about one half weight percent of a green fluorescent to provide said tape with a high degree of brightness and extended hours of emissivity.

11. The product as set forth in claim 1, consisting of a tape having at least one tapered edge; a width of about two inches and a thickness on the range of 0.025 to 0.030 inches.

12. The product as set forth in claim 11, including about one half weight percent of 0.0035 inch aluminum glitter niblets, giving a high degree of light reflectivity to the tape, under direct illumination

13. An extruded plastic tape of predetermined thickness having localized raised plateau-like portions of irregular size, shape, and orientation, surrounded by substantially laterally extending minor surface irregularities having a shirred lace-like appearance.

14. The tape as set forth in claim 13, wherein said plastic is a polyolefin

15. The method of extruding a plastic tape with a non-symmetrical, irregular surface profile having raised local plateau portions and substantially laterally extending minor lineation providing a shirrcd, lacelike appearance, consisting of the steps of: extruding a polyolefin material at a temperature in the range 400 to 415 F degrees at a pressure in the range of 2000 to 2500 pounds per square inch, and with a slow take off.

16. The method as set forth in claim 15, wherein said rate of take off is at 1500 rpm.

17. The tape as set forth in claim 13, wherein said minor surface irregularities have a shape resembling the skin folds on the foot of a Gecko lizard.

18. The tape as set forth in claim 11; wherein said plastics are polyolefin, thermoplastic elastomers selected from the group consisting of DYNAFLEX[TM] and EVATANE [TM] co polymers
